(19) United States
(12) Patent Application Publication
(10) Pub. No.: US 2026/0146655 A1
(43) Pub. Date: May 28, 2026

(54) CLUTCH DISC WEAR COMPENSATION METHOD

(71) Applicant: HYUNDAI WIA CORPORATION, Changwon-si (KR)

(72) Inventor: Eun Sol BANG, Changwon-si (KR)

(21) Appl. No.: 19/392,428

(22) Filed: Nov. 18, 2025

(30) Foreign Application Priority Data
Nov. 27, 2024 (KR) 10-2024-0171623

(51) Int. Cl. F16D 48/06; F16D 28/00

(52) U.S. Cl. CPC F16D 48/06; F16D 28/00; F16D 2500/1023; F16D 2500/10412; F16D 2500/3021; F16D 2500/3024; F16D 2500/308; F16D 2500/30803; F16D 2500/3104; F16D 2500/50296

(57) ABSTRACT

The present disclosure relates to a clutch disk wear compensation method, including a compensation value determination operation of determining a compensation value for wear of a clutch disk that comes into contact with and is spaced apart for power transmission and interruption, and a compensation value application operation of adjusting the clutch disk according to a map to which the compensation value is applied, wherein the compensation value determination operation estimates wear of the clutch disk and determines the compensation value based on a correlation between the pressure applied to the clutch disk and the output of a motor applying the pressure to the clutch disk, thereby preventing a decrease in transmitted torque due to wear of the clutch disk.

### CROSS REFERENCE TO RELATED APPLICATION

This application is based on and claims priority under 35 U.S.C. §119 to Korean Patent Application No. 10-2023-0171623, filed on November 27, 2024, in the Korean Intellectual Property Office, the disclosure of which is incorporated by reference herein in its entirety.

### BACKGROUND OF THE INVENTION

### Field of the Invention

The present disclosure relates to a clutch disc wear compensation method.

### Description of the Related Art

In general, an automobile is driven by transmitting power generated by an engine to tires through a power transmission system including a transmission, a differential gear, and the like.

Such an automobile may employ either a two-wheel drive method, in which only the front or rear wheels are driven, or a four-wheel drive method, in which both the front and rear wheels are driven.

The four-wheel drive method provides higher driving stability than the two-wheel drive method and is more suitable for rough road driving such as in mountainous terrain, and is classified into a full-time four-wheel drive method and a selectable two-wheel/four-wheel drive method.

The selectable two-wheel/four-wheel drive method requires a power transmission system such as a transfer case for distributing driving force to the front and rear wheels, and the power transmission system includes clutch discs that come into contact with and are spaced apart from each other to transmit and cut off power.

Here, the clutch discs include a first clutch disc rotatable with a first shaft and a second clutch disc rotatable with a second shaft, and the first clutch disc and the second clutch disc are pressed against each other and brought into or out of contact with each other by a ball ramp, ball screw, or the like that generates axial displacement according to the rotation of a motor.

However, in the related art, there is a problem in that the transmitted torque is reduced due to wear of the clutch discs. That is, as the first clutch disc and the second clutch disc come into contact with and are separated from each other and become worn, the thicknesses of the first clutch disc and the second clutch disc decrease over time, and when the motor rotates at a predetermined angle such that the first clutch disc and the second clutch disc come into contact with each other, the contact force between the first clutch disc and the second clutch disc in the worn state becomes smaller than the contact force between the first clutch disc and the second clutch disc in the unworn state. As a result, the driving force is distributed to the front and rear wheels differently from the intended distribution, thereby causing problems such as the vehicle failing to escape from rough terrain.

### SUMMARY OF THE INVENTION

It is an object of the present disclosure to provide a clutch disc wear compensation method capable of preventing a reduction in transmitted torque due to wear of the clutch discs.

In order to accomplish the above objects, the disclosed clutch disk wear compensation method includes a compensation value determination operation of determining a compensation value for wear of a clutch disk that comes into contact with and is spaced apart for power transmission and interruption, and a compensation value application operation of adjusting the clutch disk according to a map to which the compensation value is applied, wherein the compensation value determination operation includes estimating wear of the clutch disk and determining a compensation value based on a correlation between the pressure applied to the clutch disk and the output of a motor applying the pressure to the clutch disk.

The compensation value determination operation may further include a wear compensation control execution operation, operating the motor to press the clutch disk and monitoring the output and angle of the motor.

The compensation value determination operation may further include a system condition satisfaction determination operation, which determines whether a power transmission system including the clutch disk satisfies conditions for executing the wear compensation control execution operation, and a vehicle condition satisfaction determination operation, which determines whether a vehicle including the power transmission system satisfies conditions for executing the wear compensation control execution operation, wherein the wear compensation control execution operation may be executed when it is determined in the system condition satisfaction determination operation that the power transmission system satisfies the conditions and, in the vehicle condition satisfaction determination operation, that the vehicle satisfies the conditions.

The system condition satisfaction determination operation my include a first system condition satisfaction determination operation, which determines whether components and input values of the power transmission system are normal, a second system condition satisfaction determination operation, which determines whether a temperature of the power transmission system is within a predetermined temperature range, and a third system condition satisfaction determination operation, which determines whether conditions are present under which wear may have occurred on the clutch disk, wherein the system condition satisfaction determination operation may determine that the power transmission system satisfies the conditions for executing the wear compensation control execution operation when the first system condition satisfaction determination operation determines the components and input values are normal, the second system condition satisfaction determination operation determines the temperature is within the predetermined range, and the third system condition satisfaction determination operation determines that conditions are present under which wear may have occurred on the clutch disk.

The predetermined temperature range may be set from 20°C to 90°C.

The third system condition satisfaction determination operation may determine that conditions are present under which wear has occurred on the clutch disk based on an amount of use of the clutch disk or a traveled distance of the vehicle being equal to or greater than a predetermined value.

The vehicle condition satisfaction determination operation may include a first vehicle condition satisfaction determination operation, which determines whether a gear position of the vehicle is in a park or neutral state, a second vehicle condition satisfaction determination operation, which determines whether the vehicle ignition is off, and a third vehicle condition satisfaction determination operation, which determines whether a CAN input of the vehicle is valid, wherein the vehicle condition satisfaction determination operation may determine that the vehicle satisfies the conditions for executing the wear compensation control execution operation based on the first vehicle condition satisfaction determination operation determining that the gear position is in the park or neutral state, the second vehicle condition satisfaction determination operation determining that the ignition is off, and the third vehicle condition satisfaction determination operation determining that the CAN input is valid.

Assuming a reference output is defined as an output of the motor measured when the motor rotates by a reference angle in a state where no wear occurs on the clutch disk, the compensation value determination operation may further include a data verification operation, which estimates wear of the clutch disk and determines a wear compensation value by comparing a motor angle measured in the wear compensation control execution operation with the reference angle when a motor output measured in the wear compensation control execution operation reaches the reference output, or by comparing the motor output measured in the wear compensation control execution operation with the reference output when the motor angle measured in the wear compensation control execution operation reaches the reference angle.

The compensation value determination operation may further include a condition change determination operation, which determines whether at least one of the power transmission system or the vehicle fails to satisfy conditions for executing the wear compensation control execution operation, and a wear compensation control interruption operation, which interrupts the wear compensation control execution operation, wherein, after execution of the wear compensation control execution operation, the data verification operation may be executed when the condition change determination operation determines that the power transmission system and the vehicle satisfy the conditions, and the wear compensation control interruption operation may be executed when the condition change determination operation determines that at least one of the power transmission system or the vehicle does not satisfy the conditions.

The compensation value determination operation may further includes a data update necessity determination operation, which determines whether the existing wear compensation value should be updated with a wear compensation value determined in the data verification operation, a data update operation, which updates the existing wear compensation value with the wear compensation value determined in the data verification operation when it is determined that an update is necessary, and a data maintenance operation, which maintains the existing wear compensation value when it is determined that an update is not necessary.

### BRIEF DESCRIPTION OF THE DRAWINGS

FIG. 1 is a flowchart illustrating a clutch disc wear compensation method according to an embodiment of the present disclosure;

FIG. 2 is a flowchart illustrating in detail an operation of estimating the degree of wear of the clutch discs and determining a compensation value in the clutch disc wear compensation method of FIG. 1; and

FIG. 3 is a diagram illustrating differences between a vehicle to which the clutch disc wear compensation method of FIG. 1 is applied and a vehicle to which the method is not applied.

### DETAILED DESCRIPTION OF THE PREFERRED EMBODIMENT

Hereinafter, a clutch disc wear compensation method according to the present disclosure will be described in detail with reference to the accompanying drawings.

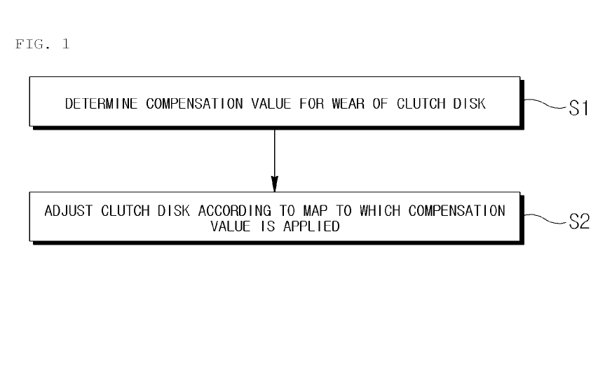

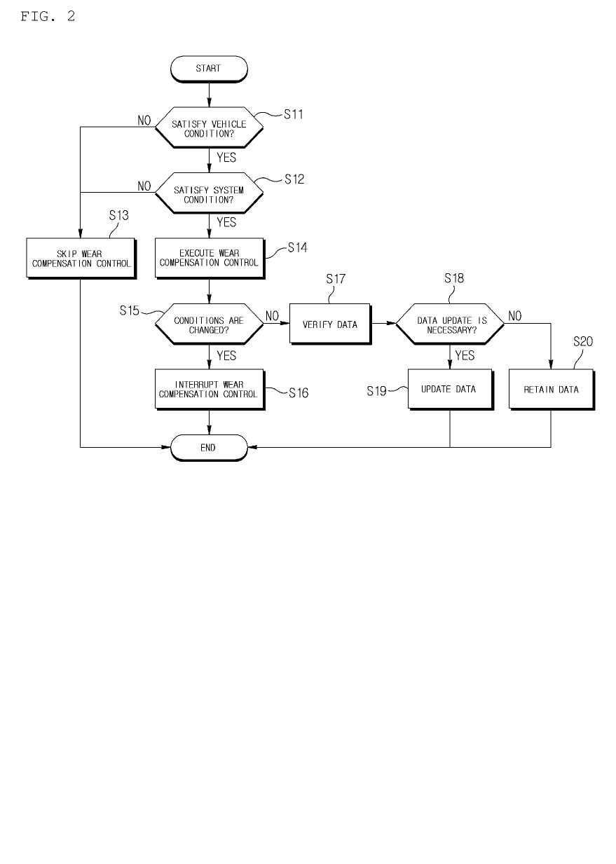

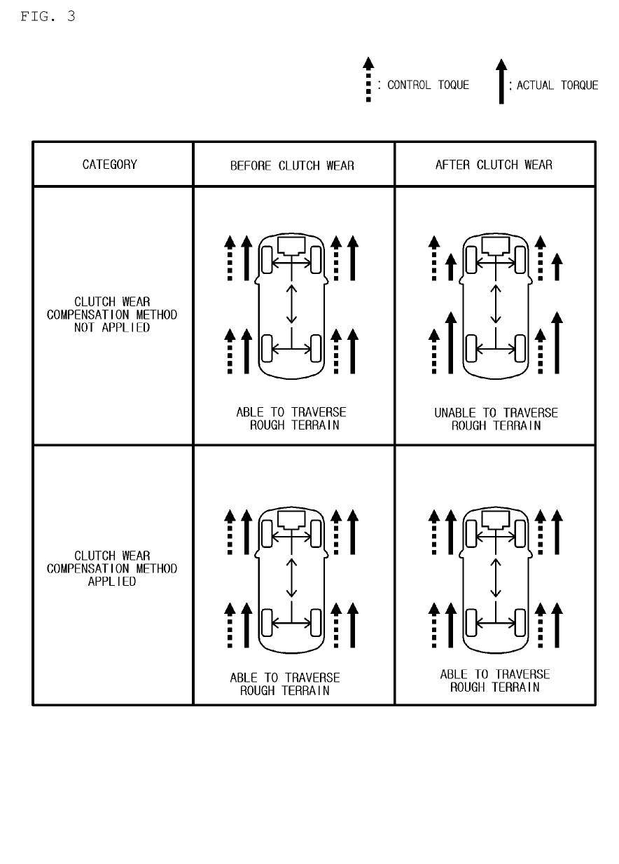

FIG. 1 is a flowchart illustrating a clutch disc wear compensation method according to an embodiment of the present disclosure, FIG. 2 is a flowchart illustrating in detail an operation of estimating the degree of wear of the clutch discs and determining a compensation value in the clutch disc wear compensation method of FIG. 1, and FIG. 3 is a diagram illustrating differences between a vehicle to which the clutch disc wear compensation method of FIG. 1 is applied and a vehicle to which the method is not applied.

Referring to FIG. 1, a clutch disk wear compensation method according to an embodiment of the present disclosure may include a compensation value determination operation S1 of determining a compensation value for wear of a clutch disk that comes into contact with and is spaced apart for power transmission and interruption, and a compensation value application operation S2 of adjusting the clutch disk according to a map to which the compensation value is applied.

Here, even in a case where it is difficult to provide a sensor capable of measuring pressure applied to the clutch disk (e.g., where the clutch disk is controlled not by hydraulic pressure but by a mechanism such as a ball ramp or ball screw), the compensation value determination operation S1 may be configured to estimate wear of the clutch disk and determine the compensation value based on a correlation between the pressure applied to the clutch disk and the output of a motor applying the pressure to the clutch disk.

Specifically, referring to FIG. 2, the compensation value determination operation S1 may include a wear compensation control execution operation S14, which operates the motor to press the clutch disk and monitors the output and angle of the motor.

Assuming the output of the motor measured as the motor rotates by a reference angle in a state where no wear of the clutch disk occurs is defined as a reference output, the compensation value determination operation S1 may further include a data verification operation S17, which estimates the wear of the clutch disk and determines a wear compensation value by comparing the motor angle measured in operation S14 with the reference angle when the motor output measured in operation S14 reaches the reference output, or by comparing the motor output measured in operation S14 with the reference output when the motor angle measured in operation S14 reaches the reference angle.

Here, estimation of a correlation between the motor output and the pressure applied to the clutch disk may be performed through one of constant speed control of the motor, motor angle step control, or motor duty control at a clutch-off position (a position with no clutch reaction force).

In addition, the wear compensation control execution operation S14 may be configured to be executed regardless of the vehicle driver’s intention in order to improve accuracy of wear estimation and determination of the compensation value for the clutch disk.

Specifically, the compensation value determination operation S1 may further include a system condition determination operation S12, which determines whether a power transmission system including the clutch disk satisfies a condition for executing the wear compensation control execution operation S14, and a vehicle condition determination operation S11, which determines whether a vehicle including the power transmission system satisfies a condition for executing operation S14, and when it is determined in operation S12 that the power transmission system satisfies the condition for executing operation S14 and it is determined in operation S11 that the vehicle satisfies the condition for executing operation S14, the wear compensation control execution operation S14 may be executed.

In FIG. 2, operation S11 is illustrated as preceding operation S12; however, the present disclosure is not limited thereto.

The system condition determination operation S12 may include a first system condition determination sub-operation, which determines whether components and input values of the power transmission system are normal, a second system condition determination sub-operation, which determines whether the temperature of the power transmission system is within a predetermined temperature range, and a third system condition determination sub-operation, which determines whether a situation in which wear of the clutch disk may have occurred has arisen, and when it is determined in the first sub-operation that the components and input values of the power transmission system are normal, in the second sub-operation that the temperature of the power transmission system is within the predetermined temperature range (e.g., 20 °C to 90 °C), and in the third sub-operation that a situation in which wear of the clutch disk may have occurred (e.g., when the clutch disk usage or the vehicle travel distance exceeds a predetermined value) has arisen, the system condition determination operation S12 may be configured to determine that the power transmission system satisfies the condition for executing the wear compensation control execution operation S14, which may be desirable for improving the accuracy of the determination of operation S12. For reference, consideration of the third system condition determination sub-operation is to prevent unnecessary execution of the determination procedure.

The vehicle condition determination operation S11 may include a first vehicle condition determination sub-operation, which determines whether the gear of the vehicle is in the parking or neutral position, a second vehicle condition determination sub-operation, which determines whether the vehicle ignition is off, and a third vehicle condition determination sub-operation, which determines the validity of CAN inputs of the vehicle, and when it is determined in the first sub-operation that the vehicle gear is in the parking or neutral position, in the second sub-operation that the vehicle ignition is off, and in the third sub-operation that the CAN inputs of the vehicle are valid, the vehicle condition determination operation S11 may be configured to determine that the vehicle satisfies the condition for executing the wear compensation control execution operation S14, which may be desirable for improving the accuracy of the determination of operation S11. For reference, consideration of the third vehicle condition determination sub-operation is to prevent misjudgment in the first vehicle condition determination sub-operation, in which the vehicle gear may be incorrectly determined to be in the parking or neutral position, and in the second vehicle condition determination sub-operation, in which the vehicle ignition may be incorrectly determined to be off, when there is an error in the vehicle’s CAN input.

Meanwhile, for example, there may be a case in which conditions change during execution of the wear compensation control execution operation S14, such as when the vehicle is restarted. To account for this, the compensation value determination operation S1 may further include a condition change determination operation S15, which determines whether at least one of the power transmission system or the vehicle no longer satisfies the condition for executing the wear compensation control execution operation S14, and a wear compensation control interruption operation S16, which interrupts operation S14, and after execution of operation S14, upon execution of operation S15, when the power transmission system and the vehicle are determined to satisfy the condition for executing operation S14, the data verification operation S17 may be executed, whereas when operation S15 determines that at least one of the power transmission system or the vehicle does not satisfy the condition for executing operation S14, operation S16 may be executed.

For reference, the unillustrated reference numeral S13 denotes a non-execution operation of the wear compensation control, which is not performed when it is determined in the system condition determination operation S12 that the power transmission system does not satisfy the condition for executing the wear compensation control execution operation S14, or when it is determined in the vehicle condition determination operation S11 that the vehicle does not satisfy the condition for executing operation S14.

Further, to improve the accuracy of wear compensation of the clutch disk through learning, the compensation value determination operation S1 may further include a data update necessity determination operation S18, which determines whether the existing wear compensation value should be updated with the wear compensation value determined in the data verification operation S17, a data update operation S19, which updates the existing wear compensation value with the wear compensation value determined in operation S17 when operation S18 determines that an update is necessary, and a data retention operation S20, which maintains the existing wear compensation value when operation S18 determines that an update is not necessary.

The clutch disk wear compensation method according to this configuration may include the compensation value determination operation S1 and the compensation value application operation S2, wherein in operation S1, the wear of the clutch disk is estimated and the compensation value is determined based on a correlation between the pressure applied to the clutch disk and the output of the motor applying that pressure, thereby preventing a decrease in transmitted torque due to clutch disk wear, such that, as illustrated in FIG. 3, even when wear occurs on the clutch disk, driving force is distributed to the front and rear wheels as intended, allowing the vehicle to traverse rough terrain.

What is claimed is:

1. A clutch disk wear compensation method, comprising:
a compensation value determination operation of determining a compensation value for wear of a clutch disk that comes into contact with and is spaced apart for power transmission and interruption; and
a compensation value application operation of adjusting the clutch disk according to a map to which the compensation value is applied,
wherein the compensation value determination operation comprises estimating wear of the clutch disk and determining a compensation value based on a correlation between the pressure applied to the clutch disk and the output of a motor applying the pressure to the clutch disk.

2. The method of claim 1, wherein the compensation value determination operation further comprises a wear compensation control execution operation, operating the motor to press the clutch disk and monitoring the output and angle of the motor.

3. The method of claim 2, wherein the compensation value determination operation further comprises:
a system condition satisfaction determination operation, which determines whether a power transmission system including the clutch disk satisfies conditions for executing the wear compensation control execution operation; and
a vehicle condition satisfaction determination operation, which determines whether a vehicle including the power transmission system satisfies conditions for executing the wear compensation control execution operation,
wherein the wear compensation control execution operation is executed when it is determined in the system condition satisfaction determination operation that the power transmission system satisfies the conditions and, in the vehicle condition satisfaction determination operation, that the vehicle satisfies the conditions.

4. The method of claim 3, wherein the system condition satisfaction determination operation comprises:
a first system condition satisfaction determination operation, which determines whether components and input values of the power transmission system are normal;
a second system condition satisfaction determination operation, which determines whether a temperature of the power transmission system is within a predetermined temperature range; and
a third system condition satisfaction determination operation, which determines whether conditions are present under which wear has occurred on the clutch disk,
wherein the system condition satisfaction determination operation determines that the power transmission system satisfies the conditions for executing the wear compensation control execution operation when the first system condition satisfaction determination operation determines the components and input values are normal, the second system condition satisfaction determination operation determines the temperature is within the predetermined range, and the third system condition satisfaction determination operation determines that conditions are present under which wear has occurred on the clutch disk.

5. The method of claim 4, wherein the predetermined temperature range is set from 20°C to 90°C.

6. The method of claim 4, wherein the third system condition satisfaction determination operation determines that conditions are present under which wear has occurred on the clutch disk based on an amount of use of the clutch disk or a traveled distance of the vehicle being equal to or greater than a predetermined value.

7. The method of claim 3, wherein the vehicle condition satisfaction determination operation comprises:
a first vehicle condition satisfaction determination operation, which determines whether a gear position of the vehicle is in a park or neutral state;
a second vehicle condition satisfaction determination operation, which determines whether the vehicle ignition is off; and
a third vehicle condition satisfaction determination operation, which determines whether a CAN input of the vehicle is valid,
wherein the vehicle condition satisfaction determination operation determines that the vehicle satisfies the conditions for executing the wear compensation control execution operation based on the first vehicle condition satisfaction determination operation determining that the gear position is in the park or neutral state, the second vehicle condition satisfaction determination operation determining that the ignition is off, and the third vehicle condition satisfaction determination operation determining that the CAN input is valid.

8. The method of claim 3, wherein, assuming a reference output is defined as an output of the motor measured when the motor rotates by a reference angle in a state where no wear occurs on the clutch disk, the compensation value determination operation further comprises a data verification operation, which estimates wear of the clutch disk and determines a wear compensation value by comparing a motor angle measured in the wear compensation control execution operation with the reference angle when a motor output measured in the wear compensation control execution operation reaches the reference output, or by comparing the motor output measured in the wear compensation control execution operation with the reference output when the motor angle measured in the wear compensation control execution operation reaches the reference angle.

9. The method of claim 8, wherein the compensation value determination operation further comprises:
a condition change determination operation, which determines whether at least one of the power transmission system or the vehicle fails to satisfy conditions for executing the wear compensation control execution operation; and
a wear compensation control interruption operation, which interrupts the wear compensation control execution operation,
wherein, after execution of the wear compensation control execution operation, the data verification operation is executed when the condition change determination operation determines that the power transmission system and the vehicle satisfy the conditions, and the wear compensation control interruption operation is executed when the condition change determination operation determines that at least one of the power transmission system or the vehicle does not satisfy the conditions.

10. The method of claim 8, wherein the compensation value determination operation further comprises:
a data update necessity determination operation, which determines whether the existing wear compensation value should be updated with a wear compensation value determined in the data verification operation;
a data update operation, which updates the existing wear compensation value with the wear compensation value determined in the data verification operation when it is determined that an update is necessary; and
a data maintenance operation, which maintains the existing wear compensation value when it is determined that an update is not necessary.
